(19) United States
(12) Patent Application Publication
(10) Pub. No.: US 2024/0356826 A1
(43) Pub. Date: Oct. 24, 2024

(54) DHCP ECOSYSTEM HEALTH CHECKS

(71) Applicant: DISNEY ENTERPRISES, INC., Burbank, CA (US)

(72) Inventors: Sameetha MAHESHWARAM, Orlando, FL (US); Daniel Eric OUELLETTE, Monrovia, CA (US); Esther M. BETANCOURT, Clermont, FL (US); Robert K. FLOYD, III, Clermont, FL (US); James Reed PHILPOTT, Seattle, WA (US)

(21) Appl. No.: 18/306,139

(22) Filed: Apr. 24, 2023

(51) Int. Cl. H04L 43/08; H04L 61/4552; H04L 61/5014

(52) U.S. Cl. CPC H04L 43/08; H04L 61/4552; H04L 61/5014

(57) ABSTRACT

One embodiment of a computer-implemented method checking the health of a domain host configuration protocol (DHCP) system comprises receiving information identifying one or more system checks to be executed on one or more components of a DHCP system, wherein the one or more system checks include at least one of a gateway system check, a domain name server (DNS) system check, a domain search list system check, or a subnet mask system check; executing the one or more systems checks, wherein each system check of the one or more system checks performs a comparison of an operating condition of the DHCP system to a target condition; and effecting creation of a ticket for recording a result of the comparison.

### BACKGROUND

### Field of the Various Embodiments

Embodiments of the present disclosure generally relate to techniques for diagnosing problems related to the health of a DHCP system.

### DESCRIPTION OF THE RELATED ART

With the rise of network computing, almost all computers in the modern enterprise are connected to the Internet. For connection to work seamlessly, a network service that resides in the network must provide a DHCP service. DHCP (Dynamic Host Configuration Protocol) is a network management protocol used on Internet Protocol (IP) networks for automatically assigning IP addresses and other communication parameters to devices connected to the network using a client-server architecture. Using DHCP eliminates the need for individually configuring network devices manually, and consists of two primary network components, a centrally installed DHCP server and client instances of the protocol stack on each computer or device to be connected to the network. When connected to the network, and periodically thereafter, a client requests a set of parameters from the DHCP server using the DHCP protocol. The parameters received include an IP address and subnet mask, a gateway IP address, and one or more DNS server IP addresses. DHCP can be implemented on networks ranging in size from residential networks to large campus networks and regional ISP networks. Many routers and residential gateways have DHCP server capability. Most residential network routers receive a unique IP address within the ISP network. Within a local network, a DHCP server assigns a local IP address to each device. While residential DHCP servers require minimal configuration and maintenance, DHCP servers for the modern enterprise can be quite complex and serve hundreds of thousands of employees.

One issue encountered with large DHCP installations is maintaining system health. The DHCP architecture is distributed by design. The decentralized nature of DHCP represents a strength in that the system can be extended and maintained by multiple parties in a geographically dispersed organization as long as certain factors are controlled. Those principles include all actors involved adhering to the architectural design, no configuration mistakes being made, an absence of malicious outside actors, and the network remaining relatively static. In practice, however, these factors are not easily controlled. For example, when implemented in large geographically dispersed campus network settings, the strength of a decentralized DHCP architecture can become a weakness. Multiple parties are often involved in the implementation and maintenance of the DHCP system and troubleshooting issues can become problematic. End users can make manual changes that unintentionally cause conflicts. Malicious actors can attempt to cause disruption. An organization rarely remains static, and the addition and removal of sites cause changes to the network configuration. And even when the problem is short-lived, the fact that everyone in an enterprise is dependent on network connectivity means that any outage has the potential to be very disruptive and costly in terms of lost productivity. Troubleshooting is often a time-consuming manual process of elimination that occurs after a disruption has been felt by end-users.

As the foregoing illustrates, what is needed are more effective and flexible techniques for monitoring the operation of all components contributing to the health of the DHCP system and alerting administrators to potential problems or symptoms before outages or performance degradation occurs.

### SUMMARY

One embodiment of a computer-implemented method checking the health of a domain host configuration protocol (DHCP) system comprises receiving information identifying one or more system checks to be executed on one or more components of a DHCP system, wherein the one or more system checks include at least one of a gateway system check, a DNS system check, a domain search list system check, or a subnet mask system check. The method further includes executing the one or more systems checks, wherein each system check of the one or more system checks performs a comparison of an operating condition of the DHCP system to a target condition. The method additionally includes effecting creation of a ticket for recording a result of the comparison.

The present disclosure describes techniques that represent several advantages over prior art solutions. The described techniques are proactive and preemptive. Issues are identified before they become problems causing outages. The techniques examine the effects of settings being used on client devices without involving and defocusing end users. The techniques also monitor the DHCP system on an ongoing basis, so problems are caught in temporal proximity to when they are introduced, thus making identification easier and minimizing impact. Finally, the techniques are comprehensive, looking at a comprehensive collection of the factors likely to degrade the health of the DHCP system. The technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1A is a conceptual illustration of a system that is configured to implement one or more aspects of the various embodiments;

FIG. 1B is a more detailed illustration of the DHCP server of FIG. 1A, according to various embodiments;

FIG. 1C is a more detailed illustration of the policies of FIG. 1A, according to various embodiments;

FIG. 1D is a more detailed illustration of the configuration information of FIG. 1A, according to various embodiments;

FIG. 2 is a conceptual illustration of a flowchart to implement the system checks according to various embodiments;

FIG. 3 is a conceptual illustration of a flowchart for performing a gateway system check, according to various embodiments;

FIG. 4 is a conceptual illustration of a flowchart for performing a DNS system check, according to various embodiments;

FIG. 5 is a conceptual illustration of a flowchart for performing a domain search list system check, according to various embodiments;

FIG. 6 is a conceptual illustration of a flowchart for performing a subnet mask system check, according to various embodiments;

FIG. 7 is a conceptual illustration of a flowchart for performing an NTP system check, according to various embodiments;

FIG. 8 is a conceptual illustration of a flowchart for performing a TFTP system check, according to various embodiments;

FIG. 9 is a conceptual illustration of a flowchart for performing a hostname override system check, according to various embodiments;

FIG. 10 is a conceptual illustration of a flowchart for performing a multi-nets system check, according to various embodiments;

FIG. 11 is a conceptual illustration of a flowchart for performing a multi-homed system check, according to various embodiments;

FIG. 12 is a conceptual illustration of a flowchart for performing a firewall drop system check, according to various embodiments;

FIG. 13 is a conceptual illustration of the method operations implemented by the system of FIG. 1A, according to various embodiments; and

FIG. 14 is a conceptual illustration of an exemplary server device hardware architecture configured to implement one or more aspects of the various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### System Overview

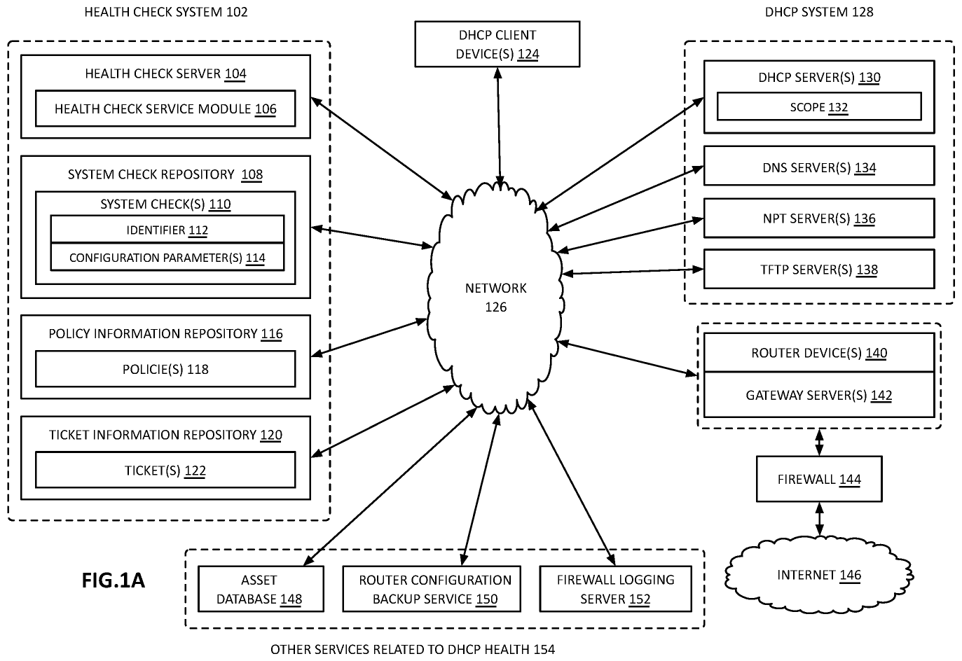

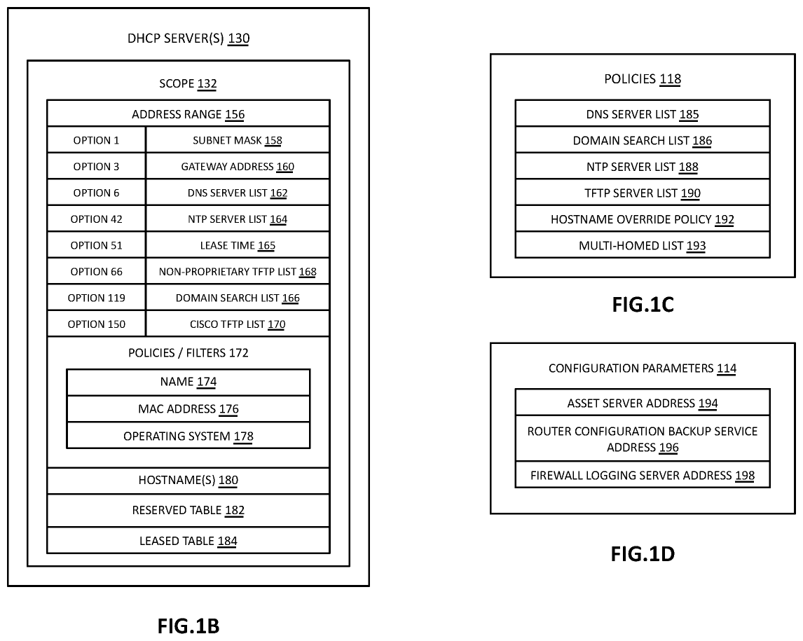

FIG. 1A is a conceptual illustration of a system that is configured to implement one or more aspects of the various embodiments. A health check system 102 is coupled to a DHCP system 128 and other services related to DHCP health 154. The DHCP system 128 provides mechanisms that allow DHCP client devices 124 to obtain IP addresses and to connect to the internet 146 through a gateway server 142. DHCP client devices 124 are shown as a single box in FIG. 1, however, any device making use of the DHCP servers 130 is to be considered DHCP client devices 124. This includes but is not limited to servers, networking equipment, loT devices, cell phones, tablets, and the like.

The health check server 104 performs a plurality of system checks 110 on the DHCP system 128. The health check server 104 includes a health check service module 106 that obtains information identifying a plurality of system checks 110 to be performed from a system check repository 108. Each system check 110 includes a unique identifier 112 which can be used to identify one or more configuration parameters 114 and one or more code modules that can be executed to perform the system check 110. For many of the plurality of system checks 110, the health check service module 106 obtains policies 118 from a policy information repository 116 identifying one or more operating conditions against which the system check results are compared. After performing the system check 110, the results are stored as a ticket 122 in a ticket information repository 120. Tickets 122 can include a time-stamp identifying a time at which the system check was executed.

In some embodiments, the health check service module 106, system check repository 108, policy information repository 116, and ticket information repository 120 are all implemented on the same server device such as health check server 104, however the present disclosure is not limited thereto. The aforementioned components can be distributed and/or grouped in any combination. Likewise, the system check repository 108, policy information repository 116, and ticket information repository 120 can all be implemented in the same database, however the disclosure is not limited thereto. The repositories can be distributed and/or grouped in any combination and stored in any suitable storage mechanism, including for example one or more XML files in a file system. The system checks 110, policies 118, and tickets 122 are all marked with the same unique identifier, enabling the linking of related data items when stored in disparate locations.

The health check service module 106 can be invoked on a periodic basis through the use of a daemon or the like, or manually by an administrator. The administrator can run the entire battery of system checks 110 identified in the system check repository 108 or can execute individual system checks 110 to aid in identifying a particular issue or problem. The system checks 110 can be executed sequentially, in parallel, or in any combination thereof.

The DHCP system 128 implements the collective DHCP service. DHCP is a network management protocol used on Internet Protocol (IP) networks for automatically assigning IP addresses and other communication parameters to devices connected to the network 126 using a client-server architecture. Using DHCP eliminates the need for individually configuring network devices manually, and consists of two primary network components, a centrally installed DHCP server 130 and DHCP client devices 124 each including an instance of the IP protocol stack to be connected to the network 126. When connected to the network 126, and periodically thereafter, a DHCP client device 124 requests a set of parameters from the DHCP server 130 using the DHCP protocol. Common parameters received, but not limited to, include an IP address, subnet mask, one or more DNS server IP addresses, and a gateway IP address, all specified in scope 132.

DHCP client devices 24 receive DNS servers addresses during the IP acquisition process from the DHCP server 130. If a router (such as router device 140) is suitably configured, the broadcast will be forwarded to other subnets and other DHCP servers 130. The message broadcast is called a “DHCP Discover” message, and each of one or more DHCP servers 130 on the network 126 responds with an offer of an IP address in a “DHCP Offer” message. The requesting DHCP client device 124 accepts one of the offers by sending a “DHCP Request” message. The process is completed when the DHCP server 130 sends a “DHCP Acknowledgement” message to the requesting DHCP client device 124.

The Network Time Protocol (NTP) is a networking protocol for clock synchronization between computer systems over packet-switched, variable-latency data networks (such as network 126). NTP is intended to synchronize all participating machines to within a few milliseconds of Coordinated Universal Time (UTC). Keeping accurate time at each device in the network 126 is relevant to DHCP because the IP addresses assigned by the DHCP server are allocated based on a temporal lease. The IP addresses are assigned to the devices, such as DHCP client devices 124, based on a lease for a limited amount of time. At the end of the lease period, the device is expected to release the IP Address so it can be made available to reuse on another device. Accurate time is necessary for the proper functioning of networks including security, job synchronization, logging, and DHCP lease management.

Firewall 144 is a security device used to prevent or limit illegal/undesirable access to a network (such as network 126) by using rules defining the traffic allowed on the network 126, any other traffic seeking to reach a destination inside the network 126 is blocked. The firewall 144 is located between the network 126 and the internet 146 serving as a final communications link between internal and external networks.

The TFTP (Trivial File Transfer Protocol) server 138 provides a TFTP service. TFTP is a simple lockstep File Transfer Protocol which allows a client to get a file from or put a file onto a remote host reachable from the network 126. One of TFTP's primary uses is in the early stages of device booting from a local area network (such as network 126) including for example network appliances such as routers, firewalls, IP office phones, and the like.

Router devices 140 connect devices, such as but not limited to DHCP client devices 124, within the network 126 by forwarding data packets between the devices. The data packets can be sent between devices or from the devices to the internet. An enterprise network can have more than one router device 140 providing scalability and redundancy should one of the router devices 140 become unavailable. Configurations for the router devices 140 can be stored in a backup such as router configuration backup service 150 for use when a router device 140 fails and must be reconfigured or replaced. Router devices 140 can also include functionality for wireless networking, static routing, network address translation (NAT), DHCP service etc.

Gateway servers 142 are responsible for receiving, analyzing and forwarding the data packets to other outside networks (such as the Internet 146). Gateway servers 142 can also include functionality for network access control, protocol conversion, etc. In some embodiments, the router functionality and gateway functionality can exist on the same physical device.

FIG. 1B is a more detailed illustration of the DHCP server 130 of FIG. 1A, according to various embodiments. DHCP servers 130 are configured using a scope 132. A scope 132 includes a consecutive address range 156 that a DHCP server 130 can draw on to fulfill an IP address request from a DHCP client device 124. By defining one or more scopes on the DHCP server 130, the DHCP server 130 can manage the distribution and assignment of IP addresses to DHCP client devices 124. When responding to a DHCP client request for an IP address, the DHCP server 130 looks to the scope 132 to determine how to respond with an IP Address and other DHCP options from the address range 156, subnet mask 158, DNS server list 162, and a gateway address 160. The IP address returned to the requesting DHCP client device 124 is allocated dynamically by the DHCP server 130 from the address range 156. The address range 156 consists of a starting address and an ending address. When allocating a new IP address, the DHCP server 130 searches for an address between and inclusive of the starting address and ending address that is not in the reservation table 182 or lease table 184. Reservation table 182 addresses are statically allocated to a particular device. Lease table 184 addresses are dynamically allocated and currently subject to a timed lease to a DHCP client device 124.

An enterprise network, such as network 126, can have more than one DHCP server 130 providing redundancy should one of the DHCP servers 130 become unavailable. In some embodiments, DHCP server redundancy is achieved by having an active DHCP server 130 and a fail-over DHCP server. Multiple failover implementations are possible, but in each case, the multiple DHCP Servers 130 must be in communication with one another to transfer state information. Otherwise, DHCP server 130 failures cause rogue network outages.

DHCP Options are used by the DHCP client devices 124 to specify which information, in addition to an IP Address, is to be returned when making a DHCP request. Common examples are option 1 for subnet mask 158, option 3 for default router or last resort gateway server 160, option 6 for DNS server list 162, option 42 for NTP server list 164, option 51 for lease time 165, option 66 for non-proprietary TFTP list 168, option 119 for domain search list 166, and option 150 for a proprietary (e.g., CISCO) TFTP server list 170.

Subnet mask 158 is used to separate the host address and the network address portions of an IP address. Subnet masks are used internally within a network 126 by router devices 140 or switches that rely on the subnet mask 158 to route data packets to suitable network destinations. Data packets that traverse over the internet 146 (or any network) do not indicate the subnet mask 158 but only reveal the IP address of the network destination. However, the routers (such as router device 140) match the destination IP address to the data packet's subnet mask to deliver the data packet to the correct network destination.

Gateway address 160 identifies an IP address for gateway server 142 that enables data flow from network 126 to the internet 146 by converting the protocol used on network 126 to the suitable internet protocol. The gateway server 142 sits between the network 126 and the Internet 146 serving as the only point of access for DHCP client devices 124 to the Internet. In some embodiments, gateway server 142 redundancy is achieved by assigning a virtual address to the gateway server 142 and having more than one server respond to requests to the virtual address.

The DNS server list 162 specifies IP addresses for one or more DNS servers 134 used for domain name lookups. DNS, or the Domain Name System, translates human-readable domain names (for example, www.disney.com) to machine-readable IP addresses (for example, 192.195.66.3). An enterprise network, such as network 126, can have more than one DNS server 134 providing redundancy should one of the DNS servers 134 become unavailable. DNS redundancy is achieved by the DHCP server 130 providing multiple DNS server addresses when an IP address is obtained by a DHCP client device 124. DNS servers work in a hierarchical fashion. When a DNS server 134 receives a request, the DNS server 134 attempts to process the request by looking into a translation table obtained by the DNS server 134. If a translation is found, the request is satisfied, and a result is returned. If a translation is not found, the DNS server 134 forwards the request to the next node in a tree-like structure. This process is repeated until a translation is found or until the top node of the tree is reached.

Scopes 132 can filter 172 DHCP client devices 124 by name 174, MAC address 176, and operating system 178 to either allow or disallow the DHCP client devices 124 from receiving an IP address. Scope policies 172 can be configured to assign different options to DHCP client devices 124 based on their name 174, MAC address 176, or operating system 178. Policies 172 can be used to specify certain types of machines or even particular machines.

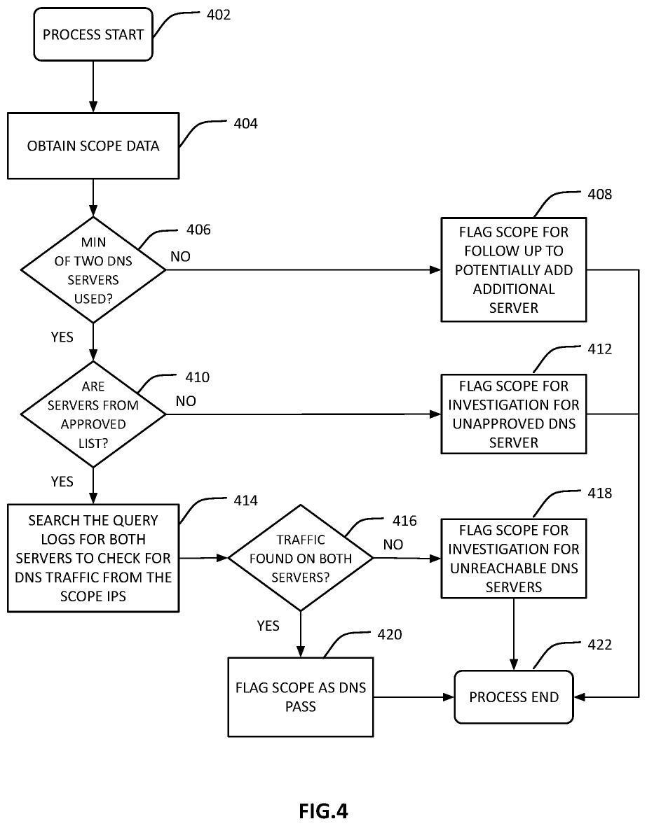

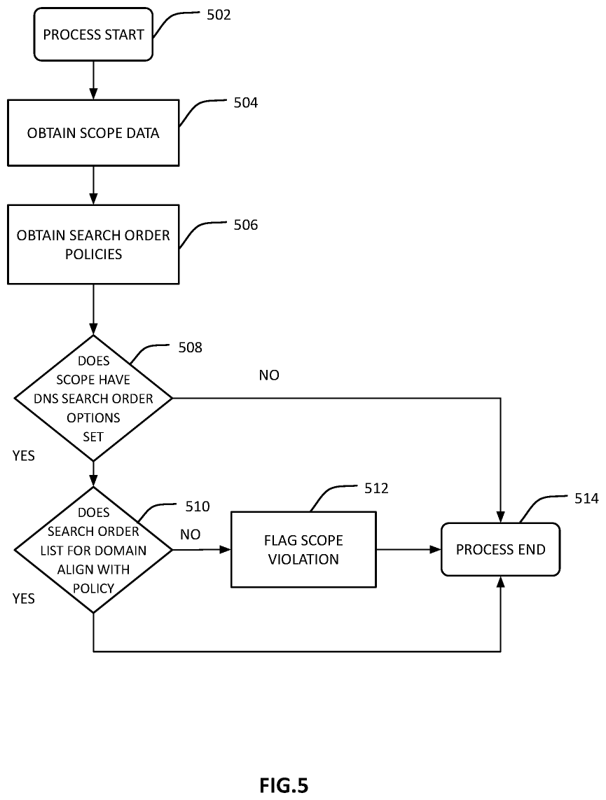

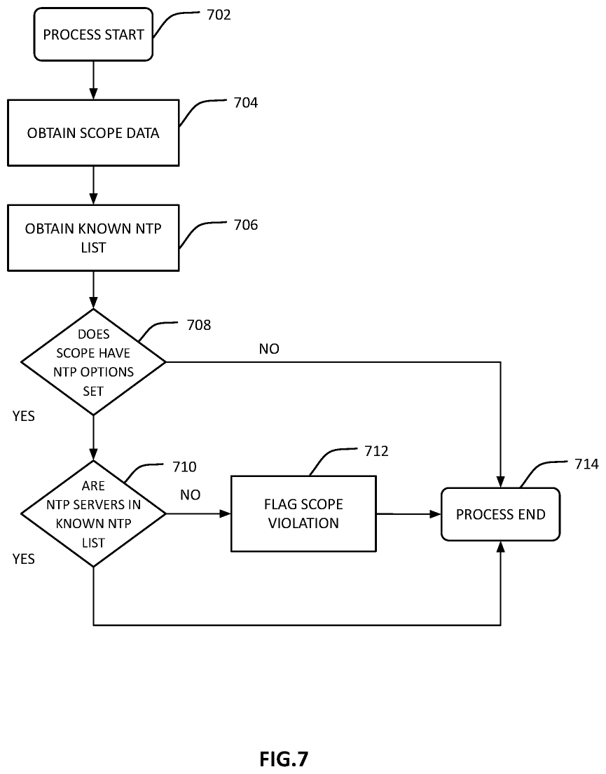

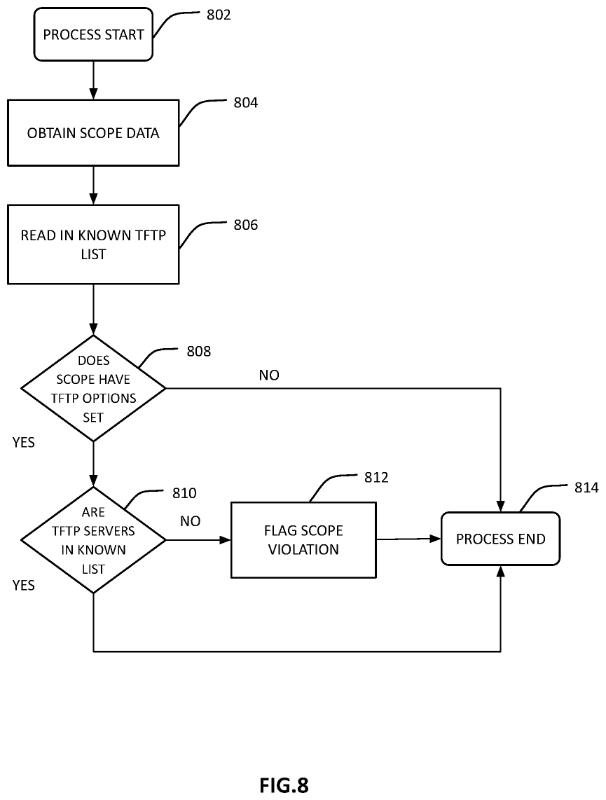

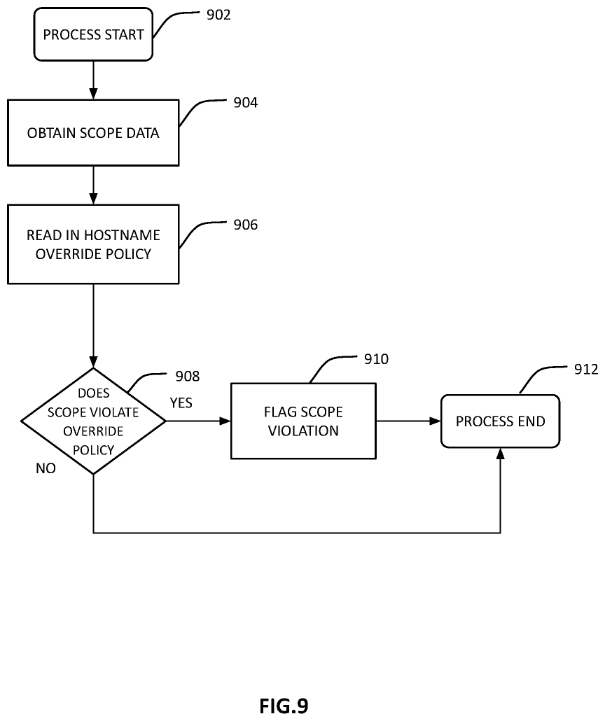

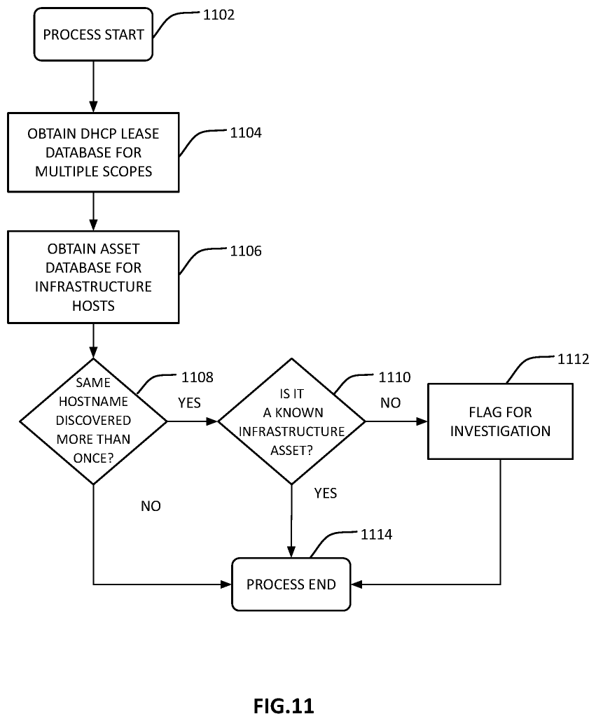

FIG. 1C is a more detailed illustration of the policies 118 of FIG. 1A, according to various embodiments. The policies 118 structure can store policy information for any or all of the system checks 110. In one embodiment, the policy 118 structure stores policy information for a DNS system check of FIG. 4, domain search list system check of FIG. 5, NTP system check of FIG. 7, TFTP server check of FIG. 8, hostname override system check of FIG. 9, and multi-homed server check of FIG. 11. For example, the DNS server list 185 stores a list of the approved DNS servers 134 and is used in the DNS system check. The domain search list 186 stores an approved ordered list of domains to search and is used in the domain search list system check. The NTP server list 188 stores a list of the approved NTP servers 136 and is used in the NTP system check. The TFTP server list 190 stores a list of the approved TFTP servers 138 used in the TFTP server check. The hostname override policy 192 is a Boolean indicating if hostnames can be overridden used in the hostname override system check. The multi-homed list 193 stores a list of the approved infrastructure assets that are allowed to be “multi-homed” and is used in the multi-homed server check.

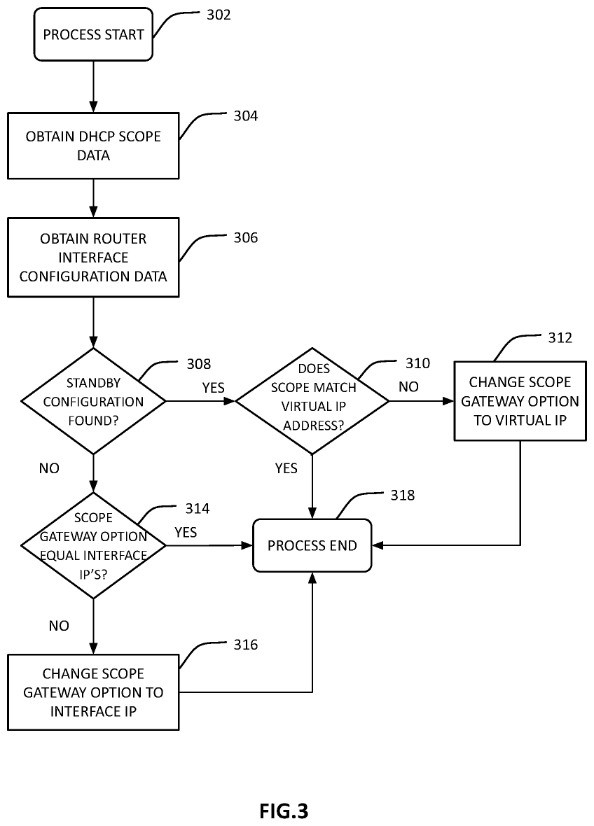

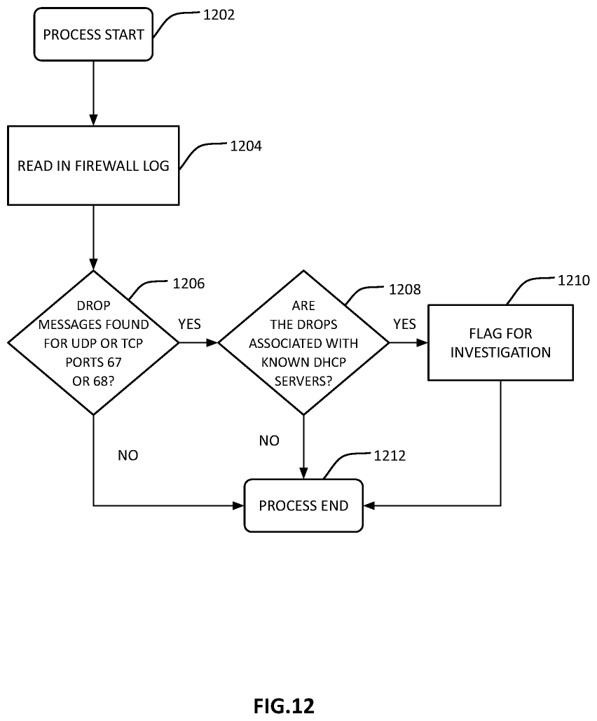

FIG. 1D is a more detailed illustration of the configuration parameters 114 of FIG. 1A, according to various embodiments. The configuration parameters 114 can store configuration parameters for any or all of the system checks 110. In one embodiment, the configuration parameters 114 store configuration parameters for a gateway system check of FIG. 3, the hostname override system check of FIG. 9, and firewall drop system check of FIG. 12. For example, the asset server address 194 is the IP address of the asset server hosting the asset database 148 used in the gateway system check. The router configuration backup service address 196 is the IP address of the server hosting the router configuration backup service 150 used in the hostname override system check. The firewall logging server address 198 is the IP address of the server hosting the firewall logging server 152 used in the firewall drop system check.

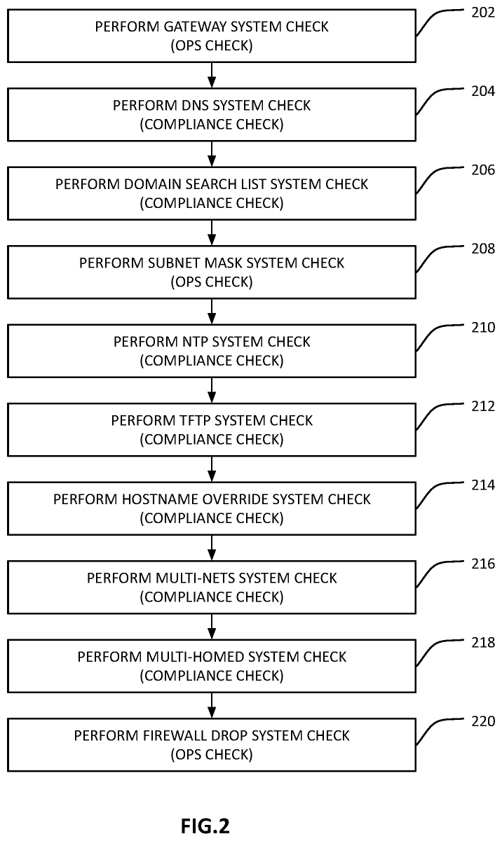

FIG. 2 is a conceptual illustration of a flowchart to implement the system checks according to various embodiments. Not all the described system checks need to be executed at the same time nor in the order listed in FIG. 2 The system checks can be performed in any order and in any combination and remain within the scope of the present disclosure. In some embodiments, if a system check 110 fails, then subsequent system checks that are part of a grouping to which the failed system check 110 belongs, are not executed. However, the system is not limited thereto. In some embodiments, all system checks 110 in the grouping to which the system check 110 belongs are executed regardless of failures or issues within the system check 110.

At step 202, the health check service module 106 performs the gateway system check of FIG. 3. The gateway system check 202 includes comparing a gateway IP address 160 set in a DHCP scope 132 to a high availability virtual IP address obtained from a configuration of the gateway server 142 to ensure that the gateway IP address 160 set in the scope 132 (option 3) is the high availability virtual IP address discovered from the gateway servers 142 when redundant gateway servers 142 are present.

At step 204, the health check service module 106 performs the DNS system check of FIG. 4. The DNS system check 204 includes comparing a DNS servers list 162 provided by the DHCP server 130 to an approved DNS server list 185 to ensure that the DNS servers list 162 provided by the DHCP server 130 (option 6) are from the approved DNS server list 185 and more than one DNS server 134 is provided.

At step 206, the health check service module 106 performs the domain search list system check of FIG. 5. The domain search list system check 206 includes comparing a domain search list 166 provided by the DHCP server 130 to an approved domain search list 186 to ensure that the domain search list 166 provided by the DHCP server 130 (option 119) is from the approved domain search list 186.

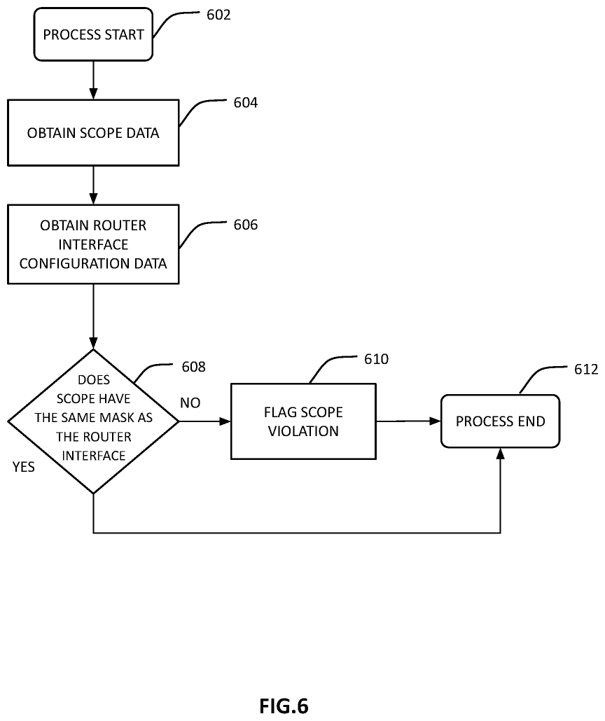

At step 208, the health check service module 106 performs the subnet mask system check of FIG. 6. The subnet mask system check 208 includes comparing a subnet mask 158 provided by the DHCP server 130 to a subnet mask obtained from a configuration of the gateway server 142 to ensure that the subnet mask 158 provided by the DHCP server 130 (option 1) matches with the subnet mask obtained from the gateway server 142. Subnet mask mismatching can cause communication issues between DHCP client devices 124 and the gateway server 142. Entry of subnet masks is prone to human error. It is an additional benefit of the present system to catch data entry errors caused by human error.

At step 210, the health check service module 106 performs the NTP system check of FIG. 7. The NTP system check 210 includes comparing an NTP server list 164 provided by the DHCP server 130 to an approved NTP server list 188 to determine if a non-approved NTP server 136 exists to ensure that the NTP server list 164 provided by the DHCP server 130 (option 42) is from the approved NTP server list 188.

At step 212, the health check service module 106 performs the TFTP system check of FIG. 8. The TFTP system check 212 includes comparing a non-proprietary TFTP list 168 to an approved non-proprietary TFTP list 190 and comparing a PROPRIETARY TFTP server list 170 provided by the DHCP server 130 to the approved TFTP list 190 to ensure that all entries in the non-proprietary TFTP list 168 (option 66) and PROPRIETARY TFTP list 170 (option 150) provided by the DHCP server 130 are from the approved TFTP server list 190.

At step 214, the health check service module 106 performs the hostname override system check of FIG. 9. The hostname override system check 214 includes comparing a hostname override occurrence to a hostname override policy 192 to determine if a non-approved hostname exists. The hostname override system check includes determining if a hostname override has occurred, and then checking the hostname override policy 192 to determine if hostname overrides are permitted.

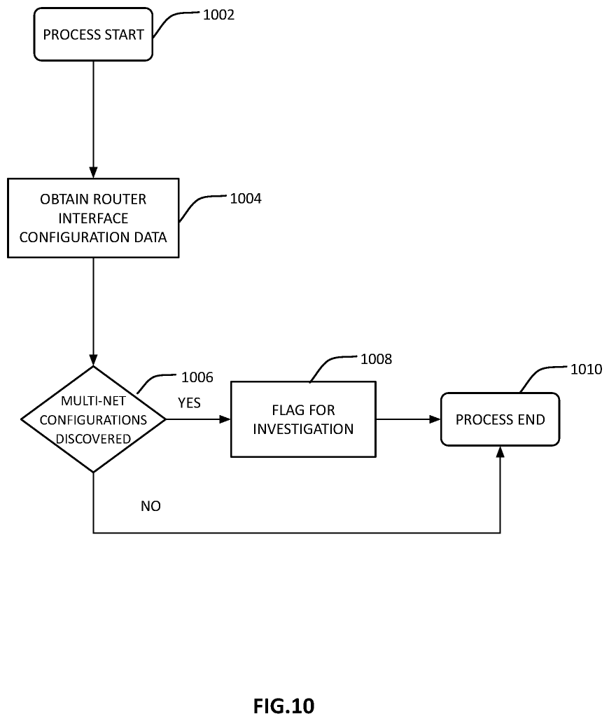

At step 216, the health check service module 106 performs the multi-nets system check of FIG. 10 to identify conditions where there are two networks associated with the same gateway address. This could arise from a “network inside a network” or two different networks with no overlap stacked into the same broadcast domain. The multi-net system check 216 includes comparing one or more gateway servers 142 to a plurality of networks 126 to determine to ensure a single broadcast domain exists. Violations are flagged for investigation.

At step 218, the health check service module 106 performs the multi-homed server check of FIG. 11 to identify non-approved multi-homed machines. The multi-homed system check 218 includes comparing lease tables 184 from a plurality of scopes (or all scopes) 132 to identify DHCP client devices 124 occurring in more than one lease table 184 as multi-homed devices and comparing the detected multi-homed devices to the multi-homed list 193 to determine if non-authorized multi-homed devices exist. Multi-homed devices can be a security risk if the networks they connect to are in different security zones, for example a public internet interface and private enterprise one. For some devices, such as firewalls, this is expected. For client workstations, printers (using ethernet and wifi), or other systems this could be a vulnerability to the security of the organization.

At step 220, the health check service module 106 performs the firewall drop system check of FIG. 12 to identify blocked DHCP requests that can impact the redundancy of the DHCP service provided by the DHCP servers 130. The firewall-drop system check 220 compares message drop entries in a firewall log to one or more DHCP client devices 124 to determine if DHCP messages are being dropped.

FIGS. 3-12 are flowcharts for implementing the individual system checks 110. A common step in many of the system checks 110 involves obtaining the scopes 132 for the DHCP servers 130 on the network 126. The system checks 110 are performed by the health check service module 106. The health check service module 106 obtains the scope 132 data by first obtaining the gateway server 142 address, and then using the gateway server 142 address to ask the gateway server 142 for the IP address of the DHCP server 130 on which the scope 132 resides.

Each of the system checks involves performing a comparison of an operating condition of the DHCP system 128 to a target condition. In many instances, the operating condition is represented by a value or values returned by the DHCP server 130 corresponding to an option and the target condition is represented a policy 118 returned from the policy information repository 116. In many instances, the comparison involves comparing two or more IP addresses. In some instances, the address can be in human-readable form (for example, www.disney.com). In some instances, the address can be in machine-readable form (for example, for example, 192.195.66.3). In some instances, the comparison can involve comparing addresses in different forms and where the addresses must be normalized to the same form before proceeding with the comparison.

FIG. 3 is a conceptual illustration of a flowchart for performing a gateway system check, according to various embodiments. The gateway system check 202 is performed by the health check service module 106 to ensure that the gateway IP address set in the scope 132 (option 3) is the high availability virtual IP address discovered from the gateway servers 142 when redundant gateway servers are present.

The method begins at step 302, and at step 304, the health check service module 106 obtains the scope 132 data. At step 306, the health check service module 106 obtains the gateway server 142 IP address from a standby configuration using the router configuration backup service 150. The router configuration backup service 150 only stores the standby configuration, which includes the gateway server 142 IP address, in the case where redundant gateway servers 142 are used, and the gateway server 142 IP address is a virtual IP address used by the redundant gateway servers. At step 308, the health check service module 106 checks to determine if the standby configuration is found. If the standby configuration is found, redundant gateway servers are being used, and the process continues at step 310. At step 310, the health check service module 106 checks to determine if the scope's gateway IP address matches the standby configuration's virtual IP address. At step 312, the health check service module 106 changes the scope gateway address to match the virtual IP address from the standby configuration if the two addresses are different and the method is complete 318. Otherwise, redundant gateway servers are not being used, and the process continues at step 314, where the health check service module 106 compares the scope gateway IP address to the IP address of the gateway server. At step 316, the health check service module 106 changes the scope gateway IP address to match the IP address of the gateway server if the two addresses are not the same.

FIG. 4 is a conceptual illustration of a flowchart for performing a DNS system check according to various embodiments. The DNS system check 204 is performed by the health check service module 106 to ensure that the DNS server list 162 provided by the DHCP server 130 (option 6) are from the approved DNS server list 185 and more than one DNS server 134 is provided.

The method begins at step 402, and at step 404, the health check service module 106 obtains the scope 132 data. At step 406, the health check service module 106 performs a check to determine if less than two DNS servers 134 are provided. If less than two DNS servers 134 are provided, then at step 408, the health check service module 106 creates a ticket 122. At step 410, the health check service module 106 checks to determine if the DNS servers 134 provided are from the approved DNS server list 185. The approved DNS server list 185 is obtained from the policy information repository 116. If the DNS servers 134 provided are not from the approved DNS server list 185, then at step 412 the health check service module 106 creates a ticket 122 identifying the issue and the process ends at step 422. Otherwise, the process continues at 414. At step 414, the health check service module 106 searches the query logs for the DNS servers 134 to determine if traffic from the IP addresses provided to DHCP client device 124 appears. If matching query traffic is not found 416, then at step 418, the health check service module 106 creates a ticket 122 indicating that an issue reaching the DNS servers 134 exists and the process ends at step 422. Otherwise the process continues at 420. If traffic from the IP addresses provided to DHCP client device 124 appears at the expected levels, then at step 420, the health check service module 106 creates a ticket indicating that the DNS system check passed validation, and the process ends at step 422.

FIG. 5 is a conceptual illustration of a flowchart for performing a domain search list system check according to various embodiments. The domain search list system check 206 is performed by the health check service module 106 to ensure that the domain search list 166 provided by the DHCP server 130 (option 119) is from the approved domain search list 186. In some instance, this issue may arise from a Windows Client getting the search order from the Active Directory Domain Controller (ADDC) instead of the DHCP server 130.

The method begins at step 502, and at step 504, the health check service module 106 obtains the scope 132 data. The approved domain search list 186 is obtained 506 from the policy information repository 116. At step 508, the health check service module 106 checks to determine if the DHCP scope 132 has an option set for providing the domain server list. If not, the process ends at step 514. Otherwise, at step 510 the health check service module 106 compares the approved domain search list 186 to the domain search list 166 returned from the DHCP server in response to option 119. If the check confirms a match, the process ends at step 514. Otherwise, at step 512, the health check service module 106 creates a ticket 122 to flag the scope violation before the process ends at step 514.

FIG. 6 is a conceptual illustration of a flowchart for performing a subnet mask system check according to various embodiments. The subnet mask system check 208 is performed by the health check service module 106 to ensure that the subnet mask 158 provided by the DHCP server 130 (option 1) matches with the subnet mask obtained from the gateway server 142. Subnet mask mismatching can cause communication issues between DHCP client devices 124 and the gateway server 142.

The method begins at step 602, and at step 604, the health check service module 106 obtains the scope 132 data. At step 606, the health check service module 106 obtains the subnet mask for the gateway server from the router device 140 interface configuration data. At step 608, the health check service module 106 checks to determine if the subnet mask 158 obtained from the DHCP server 130 scope 132 matches the subnet mask from the gateway server 142. If the check confirms that the subnet mask 158 obtained from the DHCP server 130 scope 132 matches the subnet mask from the gateway server 142, the process ends at step 612. Otherwise, at step 610, the health check service module 106 creates a ticket 122 to flag the violation before the process ends at step 612.

FIG. 7 is a conceptual illustration of a flowchart for performing an NTP system check, according to various embodiments. The NTP system check 210 is performed by the health check service module 106 to ensure that the NTP server list 164 provided by the DHCP server 130 (option 42) is from the approved NTP server list 188 list.

The method begins at step 702, and at step 704 the health check service module 106 obtains the scope 132 data. At step 706, the health check service module 106 obtains the approved NTP server list 188 from the policy information repository 116. At step 708, the health check service module 106 performs a check to determine if the DHCP scope 132 has an option set for providing an NTP server. If not, the process ends at step 714. Otherwise, the process continues as the NTP server list 164 obtained from the DHCP server 130 in response to option 42 is compared 710 to the approved NTP server list 188 from the policy information repository 116. If the check confirms that the NTP server 136 from the scope 132 is on the approved list, the process ends at step 714. Otherwise, at step 712, the health check service module 106 creates a ticket 122 to flag the violation before the process ends at step 714.

FIG. 8 is a conceptual illustration of a flowchart for performing a TFTP system check, according to various embodiments. The TFTP system check 212 is performed by the health check service module 106 to ensure that the non-proprietary TFTP list 168 (option 66) and PROPRIETARY TFTP server list 170 (option 150) provided by the DHCP server is from the approved TFTP server list 190.

The method begins at step 802, and at step 804, the health check service module 106 obtains the scope 132 data. At step 806, the health check service module 106 obtains the approved TFTP server list 190 from the policy information repository 116. At step 808, the health check service module 106 checks to determine if the DHCP scope 132 has an option set for providing an TFTP server 138. If not, the process ends at step 814. Otherwise, the process continues at as the TFTP server 138 from the DHCP server 130 in response to (option 66 non-proprietary, 150 PROPRIETARY) is compared 810 to the approved TFTP server list 190 from the policy information repository 116. If the check confirms that the TFTP server 138 from the scope 132 is on the approved list, the process ends at step 814. Otherwise, at step 812 the health check service module 106 creates a ticket 122 to flag the violation before the process ends at step 814.

FIG. 9 is a conceptual illustration of a flowchart for performing a hostname override system check, according to various embodiments. The hostname override system check 214 is performed by the health check service module 106 to ensure that the hostname override policy 192 is adhered to. A hostname 180 is an alphanumeric name of a machine and is used to identify a machine in a local network. The hostname 180 is different than the machine's MAC address or IP address. Changing the hostname 180 of a computer should also result in the DNS entry for that computer being changed. This allows other devices on the network 126 to find the machine by its new hostname 180 after the hostname 180 changes. In some enterprise networks, hostname overriding is not allowed, as it can interfere with asset management efforts. In addition, hostname overriding can cause security issues by making it more difficult to identify machines that should not be on the network.

The method begins at step 902, and at step 904, the health check service module 106 obtains the scope 132 data. At step 906, the health check service module 106 obtains the hostname override policy 192 from the policy information repository 116. At step 908, the health check service module 106 checks to determine if a hostname has been changed and if the change is allowed based on the hostname override policy 192 obtained from the policy information repository 116. If the hostname has been changed and policy does not allow hostname overriding then a violation has occurred, and at step 910 the health check service module 106 creates a ticket 122 to flag the violation before the process ends at step 912. Otherwise, the process ends at step 912.

FIG. 10 is a conceptual illustration of a flowchart for performing a multi-nets system check, according to various embodiments. The multi-nets system check 216 is performed by the health check service module 106 to identify conditions where two networks associated with the same gateway interface exists, such as a “network inside a network”. An interface can have multiple IP address assignments assigned to it in separate or overlapping address spaces. Overlapping spaces often signal a misconfiguration. Separate spaces are indicative of a temporary condition for an IP network migration. The condition can legitimately occur during a network migration where a new network is being created and one or more (or all) of the machines on the existing network are being migrated over to the new network. At the end, the two networks should be separated, or if all machines are moved, the old network should be removed. However, the co-existence of the two networks should viewed as atypical and flagged for investigation.

The method begins at step 1002, and at step 1004, the health check service module 106 obtains the interface configuration data from router device 140. At step 1006, the health check service module 106 checks to determine if the router interfaces are configured to provide more than one local network with internet communication. If the check indicates that the router is configured to provide more than one local network with internet communication, then at step 1008, the health check service module 106 creates a ticket 122 to flag the condition, and the process ends at step 1010. Otherwise, the process ends at step 1010.

FIG. 11 is a conceptual illustration of a flowchart for performing a multi-homed system check, according to various embodiments. The multi-homed system check 218 is performed by the health check service module 106 to identify non-approved multi-homed machines. As a policy, it can be desirable to limit DHCP client devices 124 on a local network to be limited to that single local network. If a DHCP client device 124 is allowed to connect to multiple networks, the situation can arise where one of the networks is low security and the other is high security, exposing the high-security network to a security breach.

The method begins at step 1102, and at step 1104, the health check service module 106 obtains lease tables 184 for multiple scopes 132. If the same DHCP client device 124 appears in more than one lease table 184, they are termed “multi-homed”. However, while being multi-homed is a concern for clients and servers, it may not be of equal concern for all machine types. Infrastructure assets, such as routers and firewalls should never occur in lease tables 184, identified as multi-homed and are not approved should be flagged for investigation. A list of the infrastructure assets that are allowed to be multi-homed is determined from the asset database 148 and stored as a policy 118 as multi-homed list 193. At step 1106, the health check service module 106 obtains the multi-homed list 193. At step 1108, the health check service module 106 obtains security zone information. The security zone information stores data identifying one or more networks with matching access policy settings. At step 1110, the health check service module 106 performs a check to determine if the same hostname is discovered in more than one security zone and if the hostname is not on the multi-homed list 193. If no machines met that criterion, then the process ends at step 1114. If the hostname is discovered in more than one security zone and is not on the multi-homed list 193, then the hostname is identified as multi-homed. For each machine that is identified as multi-homed, at step 1112, the health check service module 106 creates a ticket 122 to flag the non-approved multi-homed machines and the process ends at step 1114. One ticket 122 for each non-approved multi-homed machine can be created, one ticket 122 for all non-approved multi-homed machines, or any combination thereof.

FIG. 12 is a conceptual illustration of a flowchart for performing a firewall drop system check, according to various embodiments. The firewall drop system check 220 is performed by the health check service module 106 to identify blocked DHCP requests that can impact the redundancy of the DHCP service provided by the DHCP servers 130. In one implementation, the DHCP protocol uses UDP as the transport protocol and uses UDP 67/68 ports. The DHCP client device 124 sends a request message to port 68 of the DHCP server 130, and the DHCP server 130 responds with a reply message to port 67 of the DHCP client device 124. DHCPv6 packets are carried over UDPv6 using UDP ports 546/547.

The method begins at step 1202, and at step 1204, the health check service module 106 obtains a firewall log obtained from the firewall logging server 152. To ensure DHCP client devices 124 are communicating efficiently with the DHCP server 130, at step 1206, the health check service module 106 performs a check to determine if the firewall log obtained from the firewall logging server 152 includes any entries indicating that messages have been dropped on port 68 of the DHCP server 130 and/or port 67 of DHCP client devices 124. TCP traffic is also checked. At step 1208, the drops are inspected to determine if they are associated with known DHCP servers 130. Drops that are associated with known DHCP servers 130 should not be ignored (but rogue requests are). If UDP/TCP drops on the relevant ports are detected in the firewall log obtained from the firewall logging server 152 and are from known DHCP servers 130, then at step 1210, the health check service module 106 creates a ticket 122 to flag the issue, and the process ends at step 1212. Otherwise, the process ends at step 1212.

### Process Overview

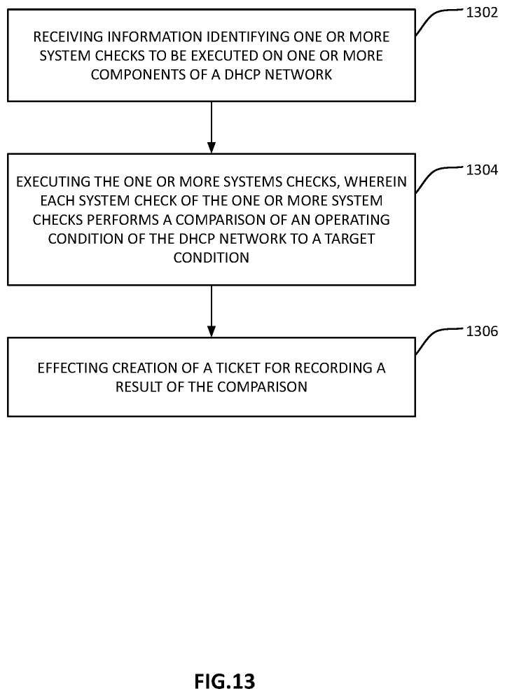

FIG. 13 is a flow diagram of method steps for checking the health of a domain host configuration protocol (DHCP) system, according to various embodiments. Although the method steps are described in conjunction with the systems of FIGS. 1-12, persons of ordinary skill in the art will understand that any system configured to perform the method steps, in any order, is within the scope of the present disclosure.

As shown in FIG. 13, method 1300 begins at step 1302, where the health check service module 106 identifies a series of system checks to be executed on a DHCP system 128. In one implementation, a first group of system checks 110 includes the gateway system check 202, a DNS system check 204, a domain search list system check 206, and a subnet mask system check 208 and a second group of system checks include an NTP system check 210, a TFTP system check 212, a hostname override system check 214, a multi-net system check 216, a multi-homed system check 218, and a firewall-drop system check 220. In one embodiment, the DHCP system 128 includes a DHCP server 130, a DNS server 134, a router device 140, and a gateway server 142. The DHCP system 128 can further include an NTP server 136 and a TFTP server 138. The system checks 110 can be packaged as part of the health check service module 106 or as an individual system check 110 modules (or in combinations) and are invoked by the health check service module 106. The DHCP system 128 implements the collective DHCP service. When connected to a network 126, and periodically thereafter, a DHCP client device 124 requests a set of parameters from the DHCP server 130 using the DHCP protocol. Common parameters received include an IP address from the address range 156 managed by the scope 132, a subnet mask 158, one or more DNS server IP addresses 162, and a gateway server IP address 160, all specified in a scope 132 at the DHCP server 130.

At step 1304, the health check service module 106 executes the one or more systems checks. Each system check of the one or more system checks performs a comparison of an operating condition of the DHCP system 128 to a target condition. For some of the one or more system checks 110, the target condition for the system check 110 is determined based on a policy 118 from the policy information repository 116. For example, a policy 118 can specify a list of server addresses that must include a server address returned from the DHCP server 130. For some of the one or more system checks 110, a configuration parameter 114 for the system check 110 can be obtained from the system check repository 108. For some of the one or more system checks 110, the configuration parameter 114 can be used to specify the address of a machine from which to obtain information for a comparison performed by the system check 110. The system checks can be executed periodically from a daemon or manually by an administrator.

At step 1306, the health check service module 106 creates a ticket 122 for recording a result of the comparison performed by the system check. In some embodiments, the ticket 122 includes information identifying the system check 110 to which the ticket 122 applies, a timestamp indicating a time at which the system check 110 was executed, and one or more flags identifying one or more system checks 110 where the operating condition of the DHCP system 128 did not meet the target condition. When executed by a daemon, a notification indicating that the one or more system checks were executed can be automatically sent to an administrator by the health check service module 106.

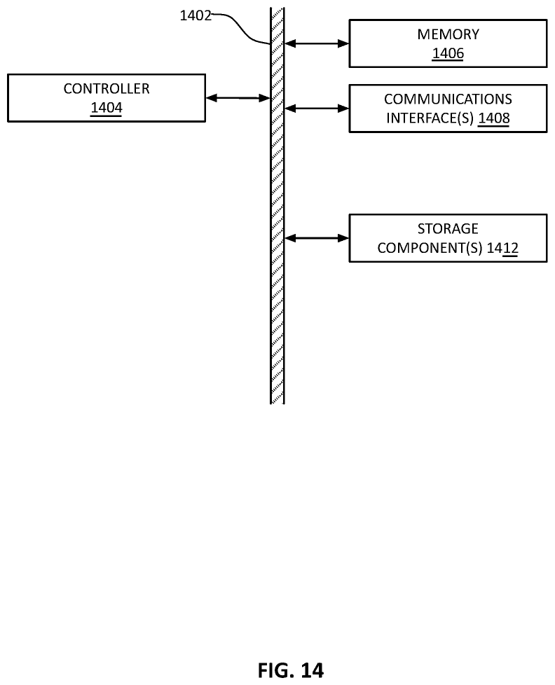

Referring to FIG. 14, an exemplary server device hardware architecture configured to implement one or more aspects of the various embodiments is shown 1400. The health check server 104 adheres to the exemplary server device hardware architecture. The health check server 104 includes a controller 1404 communicatively connected to memory 1406, one or more communications interfaces 1408, and one or more secondary storage devices 1412 by a bus 1402 or similar mechanism. The controller 1404 is, for example a microprocessor, digital ASIC, FPGA, or the like. In this embodiment, the controller 1404 is a microprocessor, and the software application, such as the health check service module 106, is implemented in software and stored in the memory 1406 for execution by the controller 1404. However, the present disclosure is not limited thereto. The aforementioned module may be implemented in software, hardware, or a combination thereof. The servers also include a communication interface 1408 enabling the servers to connect to the network 126. For example, the communications interface 1408 is a wired interface such as an Ethernet interface. However, the present disclosure is not limited thereto. The servers include one or more secondary storage components 1412. The secondary storage components 1412 are digital data storage components such as, for example, one or more hard disk drives. However, the present invention is not limited thereto. In some embodiments, the server is one or more rack mount servers and/or a blade servers. Server devices are often optimized for speed, throughput, power consumption, and reliability.

In sum, techniques are disclosed that enable checking the health of a domain host configuration protocol (DHCP) system. The techniques are performed by a health check server module and include receiving information identifying system checks. The DHCP system can include, but is not limited to, elements such as a DHCP server, DNS server, router device, gateway server, NTP server, and TFTP server. The system checks can include various combinations of a gateway system check, DNS system check, domain search list system check, subnet mask system check, NTP system check, TFTP system check, hostname override system check, multi-net system check, multi-homed system check, and firewall-drop system check. The system checks each include performing a comparison of an operating condition to a target condition. In some embodiments, the system check determines the target condition based on a policy obtained from a policy information repository. In some embodiments, the system check determines the target condition based on obtaining information from other services related to DHCP health. In some embodiments, a system check is initialized based on applying a configuration parameter. The system checks can be run periodically based on a daemon or on-demand by an administrator. A ticket is created to record the result of the comparison of the system check. The ticket can include elements such as information identifying the system check to which the ticket applies, a timestamp indicating the time at which the system check was executed, and one or more flags identifying instances where the operating condition did not meet or exceed the target condition. Notifications can be sent to the system administrator when system checks are executed and/or tickets are created.

The present disclosure describes techniques that represent several advantages over prior art solutions. The described techniques are proactive and preemptive. Issues are identified before they become problems causing outages. The techniques examine the effects of settings being used on client devices without involving and defocusing end users. The techniques can also monitor the DHCP system on an ongoing basis, so problems are caught in temporal proximity to when they are introduced, thus making identification easier and minimizing impact. Finally, the techniques are comprehensive, looking at a comprehensive collection of the factors likely to degrade the health of the DHCP system. The technical advantages provide one or more technological advancements over prior art approaches.

1. In some embodiments, a computer-implemented method for checking the health of a domain host configuration protocol (DHCP) system, the method comprising: receiving information identifying one or more system checks to be executed on one or more components of a DHCP system, wherein the one or more system checks include at least one of a gateway system check, a domain name server (DNS) system check, a domain search list system check, or a subnet mask system check; executing the one or more systems checks, wherein each system check of the one or more system checks performs a comparison of an operating condition of the DHCP system to a target condition; and effecting creation of a ticket for recording a result of the comparison.

2. The method of clause 1 wherein the gateway system check comprises: comparing a gateway IP address from a DHCP server to a virtual IP address obtained from a configuration of a gateway server to ensure that the gateway IP address from the DHCP server is the virtual IP address discovered from gateway servers when redundant gateway servers exist.

3. The method of clauses 1 or 2 wherein the DNS system check comprises: comparing a DNS servers list provided by a DHCP server to an approved DNS server list to ensure that all servers listed on the DNS servers list provided by a DHCP server are from the approved DNS server list.

4. The method of clauses 1-3 wherein the domain search list system check comprises: comparing a domain search list provided by a DHCP server to an approved domain search list to ensure that all servers listed on the domain search list provided by a DHCP server are from the approved domain search list.

5. The method of clauses 1-4 wherein the subnet mask system check comprises: comparing a subnet mask provided by a DHCP server to a subnet mask obtained from a configuration of a gateway server to ensure that the subnet mask provided by the DHCP server matches the subnet mask obtained from the gateway server.

6. The method of clauses 1-5 wherein the one or more system checks includes a Network Time Protocol (NTP) system check comprising: comparing an NTP server list provided by a DHCP server to an approved NTP server list to ensure that all servers listed on the NTP server list provided by a DHCP server are from the approved NTP server list.

7. The method of clauses 1-6 wherein the one or more system checks includes a Trivial File Transfer Protocol (TFTP) system check comprising: comparing a non-proprietary TFTP server list provided by a DHCP server to an approved non-proprietary TFTP list to ensure that all servers listed on the non-proprietary TFTP server list provided by a DHCP server are from the approved non-proprietary TFTP server list; and comparing a proprietary TFTP server list provided by a DHCP server to an approved proprietary TFTP server list to ensure that all servers listed on the proprietary TFTP server list provided by a DHCP server are from the approved proprietary TFTP server list.

8. The method of clauses 1-7 wherein the one or more system checks includes a hostname override system check comprising: comparing a hostname override occurrence to a hostname override policy to determine if non-approved hostname overrides exist.

9. The method of clauses 1-8 wherein the one or more system checks includes a multi-net system check comprising: comparing one or more gateway servers associated with each of a plurality of networks to determine if more than one of the plurality of networks are assigned to a same gateway server.

10. The method of clauses 1-9 wherein the one or more system checks includes a multi-homed system check comprising: comparing lease tables from a plurality of scopes to identify DHCP client devices occurring in more than one lease table as multi-homed devices and comparing the multi-homed devices to machine names occurring in an asset database to determine if non-authorized multi-homed devices exist.

11. The method of claim clauses 1-10 wherein the one or more system checks includes a firewall-drop system check comprising: comparing messages drop entries in a firewall log to one or more DHCP client devices to determine if DHCP messages are being dropped.

12. In some embodiments, one or more non-transitory computer-readable media storing instructions that, when executed by one or more processors, cause the one or more processors to perform the steps of: receiving information identifying one or more system checks to be executed on one or more components of a domain host configuration protocol (DHCP) system, wherein the one or more system checks include at least one of a gateway system check, a domain name server (DNS) system check, a domain search list system check, or a subnet mask system check; executing the one or more systems checks, wherein each system check of the one or more system checks performs a comparison of an operating condition of a DHCP system to a target condition; and effecting creation of a ticket for recording a result of the comparison.

13. The one or more non-transitory computer-readable media of clause 12 wherein executing the one or more system checks comprises: identifying a policy specifying the operating condition against which a system check result is compared; and setting the target condition based on the policy.

14. The one or more non-transitory computer-readable media of clauses 12 or 13 wherein executing the one or more system checks comprises: identifying a configuration parameter specifying an initial condition for a system check of the one or more system checks, and applying the configuration parameter to the system check of the one or more system checks.

15. The one or more non-transitory computer-readable media of clauses 12-14 wherein executing the one or more system checks comprises: executing the one or more system checks periodically from a daemon, or executing the one or more system checks on demand.

16. The one or more non-transitory computer-readable media of clauses 12-15 wherein executing the one or more system checks periodically from the daemon comprises: transmitting, in response to executing the one or more system checks periodically from the daemon, a notification indicating that the one or more system checks were executed.

17. The one or more non-transitory computer-readable media of clauses 12-16 wherein the ticket includes information identifying: a system check of the one or more system checks to which the ticket applies; a timestamp indicating a time at which a system check of the one or more system checks was executed; and one or more flags identifying one or more system checks where the operating condition of the DHCP system did not meet the target condition.

18. In some embodiments, a system comprising: a memory storing a health check service module; and a processor coupled to the memory that executes an alert module to perform the steps of: receiving information identifying one or more system checks to be executed on one or more components of a domain host configuration protocol (DHCP) system, wherein the one or more system checks include at least one of a gateway system check, a domain name server (DNS) system check, a domain search list system check, or a subnet mask system check; executing the one or more systems checks, wherein each system check of the one or more system checks performs a comparison of an operating condition of a DHCP system to a target condition; and effecting creation of a ticket for recording a result of the comparison.

19. The system of clause 18 wherein: the gateway system check comprises: comparing a gateway IP address from a DHCP server to a virtual IP address obtained from a configuration of a gateway server to ensure that the gateway IP address from the DHCP server is the virtual IP address discovered from gateway servers when redundant gateway servers exist; the DNS system check comprises: comparing a DNS servers list provided by a DHCP server to an approved DNS server list to ensure that all servers listed on the DNS servers list provided by a DHCP server are from the approved DNS server list; the domain search list system check comprises: comparing a domain search list provided by a DHCP server to an approved domain search list to ensure that all servers listed on the domain search list provided by a DHCP server are from the approved domain search list; and the subnet mask system check comprises: comparing a subnet mask provided by a DHCP server to a subnet mask obtained from a configuration of a gateway server to ensure that the subnet mask provided by the DHCP server matches the subnet mask obtained from the gateway server.

20. The system of clauses 18 or 19 wherein the one or more system checks include: a Network Time Protocol (NTP) system check comprising: comparing an NTP server list provided by a DHCP server to an approved NTP server list to ensure that all servers listed on the NTP server list provided by a DHCP server are from the approved NTP server list; a Trivial File Transfer Protocol (TFTP) system check comprising: comparing a non-proprietary TFTP server list provided by a DHCP server to an approved non-proprietary TFTP list to ensure that all servers listed on the non-proprietary TFTP server list provided by a DHCP server are from the approved non-proprietary TFTP server list; and comparing a Proprietary TFTP server list provided by a DHCP server to an approved Proprietary TFTP server list to ensure that all servers listed on the Proprietary TFTP server list provided by a DHCP server are from the approved Proprietary TFTP server list; a hostname override system check comprising: comparing a hostname override occurrence to a hostname override policy to determine if non-approved hostname overrides exist; a multi-net system check comprising: comparing one or more gateway servers associated with each of a plurality of networks to determine if more than one of the plurality of networks are assigned to a same gateway server; a multi-homed system check comprising: comparing lease tables from a plurality of scopes to identify DHCP client devices occurring in more than one lease table as multi-homed devices and comparing the multi-homed devices to machine names occurring in an asset database to determine if non-authorized multi-homed devices exists; and a firewall-drop system check comprising: comparing messages drop entries in a firewall log to one or more DHCP client devices to determine if DHCP messages are being dropped and wherein the at least one of the gateway system check, the domain name server (DNS) system check, the domain search list system check, or the subnet mask system check includes all of the gateway system check, the domain name server (DNS) system check, the domain search list system check, the subnet mask system check, the Network Time Protocol (NTP) system check, the Trivial File Transfer Protocol (TFTP) system check, the hostname override system check, the multi-net system check, the multi-homed system check, and the firewall-drop system check.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for checking the health of a domain host configuration protocol (DHCP) system, the method comprising:
receiving information identifying one or more system checks to be executed on one or more components of a DHCP system, wherein the one or more system checks include at least one of a gateway system check, a domain name server (DNS) system check, a domain search list system check, or a subnet mask system check;
executing the one or more systems checks, wherein each system check of the one or more system checks performs a comparison of an operating condition of the DHCP system to a target condition; and
effecting creation of a ticket for recording a result of the comparison.

2. The method of claim 1 wherein the gateway system check comprises:
comparing a gateway IP address from a DHCP server to a virtual IP address obtained from a configuration of a gateway server to ensure that the gateway IP address from the DHCP server is the virtual IP address discovered from gateway servers when redundant gateway servers exist.

3. The method of claim 1 wherein the DNS system check comprises:
comparing a DNS servers list provided by a DHCP server to an approved DNS server list to ensure that all servers listed on the DNS servers list provided by a DHCP server are from the approved DNS server list.

4. The method of claim 1 wherein the domain search list system check comprises:
comparing a domain search list provided by a DHCP server to an approved domain search list to ensure that all servers listed on the domain search list provided by a DHCP server are from the approved domain search list.

5. The method of claim 1 wherein the subnet mask system check comprises:
comparing a subnet mask provided by a DHCP server to a subnet mask obtained from a configuration of a gateway server to ensure that the subnet mask provided by the DHCP server matches the subnet mask obtained from the gateway server.

6. The method of claim 1 wherein the one or more system checks includes a Network Time Protocol (NTP) system check comprising:
comparing an NTP server list provided by a DHCP server to an approved NTP server list to ensure that all servers listed on the NTP server list provided by a DHCP server are from the approved NTP server list.

7. The method of claim 1 wherein the one or more system checks includes a Trivial File Transfer Protocol (TFTP) system check comprising:
comparing a non-proprietary TFTP server list provided by a DHCP server to an approved non-proprietary TFTP list to ensure that all servers listed on the non-proprietary TFTP server list provided by a DHCP server are from the approved non-proprietary TFTP server list; and
comparing a proprietary TFTP server list provided by a DHCP server to an approved proprietary TFTP server list to ensure that all servers listed on the proprietary TFTP server list provided by a DHCP server are from the approved proprietary TFTP server list.

8. The method of claim 1 wherein the one or more system checks includes a hostname override system check comprising:
comparing a hostname override occurrence to a hostname override policy to determine if non-approved hostname overrides exist.

9. The method of claim 1 wherein the one or more system checks includes a multi-net system check comprising:
comparing one or more gateway servers associated with each of a plurality of networks to determine if more than one of the plurality of networks are assigned to a same gateway server.

10. The method of claim 1 wherein the one or more system checks includes a multi-homed system check comprising:
comparing lease tables from a plurality of scopes to identify DHCP client devices occurring in more than one lease table as multi-homed devices and comparing the multi-homed devices to machine names occurring in an asset database to determine if non-authorized multi-homed devices exist.

11. The method of claim 1 wherein the one or more system checks includes a firewall-drop system check comprising:
comparing messages drop entries in a firewall log to one or more DHCP client devices to determine if DHCP messages are being dropped.

12. One or more non-transitory computer-readable media storing instructions that, when executed by one or more processors, cause the one or more processors to perform the steps of:
receiving information identifying one or more system checks to be executed on one or more components of a domain host configuration protocol (DHCP) system, wherein the one or more system checks include at least one of a gateway system check, a domain name server (DNS) system check, a domain search list system check, or a subnet mask system check;
executing the one or more systems checks, wherein each system check of the one or more system checks performs a comparison of an operating condition of a DHCP system to a target condition; and
effecting creation of a ticket for recording a result of the comparison.

13. The one or more non-transitory computer-readable media of claim 12 wherein executing the one or more system checks comprises:
identifying a policy specifying the operating condition against which a system check result is compared; and
setting the target condition based on the policy.

14. The one or more non-transitory computer-readable media of claim 12 wherein executing the one or more system checks comprises:
identifying a configuration parameter specifying an initial condition for a system check of the one or more system checks, and
applying the configuration parameter to the system check of the one or more system checks.

15. The one or more non-transitory computer-readable media of claim 12 wherein executing the one or more system checks comprises:
executing the one or more system checks periodically from a daemon, or
executing the one or more system checks on demand.

16. The one or more non-transitory computer-readable media of claim 15 wherein executing the one or more system checks periodically from the daemon comprises:
transmitting, in response to executing the one or more system checks periodically from the daemon, a notification indicating that the one or more system checks were executed.

17. The one or more non-transitory computer-readable media of claim 12 wherein the ticket includes information identifying:
a system check of the one or more system checks to which the ticket applies;
a timestamp indicating a time at which a system check of the one or more system checks was executed; and
one or more flags identifying one or more system checks where the operating condition of the DHCP system did not meet the target condition.

18. A system comprising:
a memory storing a health check service module; and
a processor coupled to the memory that executes an alert module to perform the steps of:
receiving information identifying one or more system checks to be executed on one or more components of a domain host configuration protocol (DHCP) system, wherein the one or more system checks include at least one of a gateway system check, a domain name server (DNS) system check, a domain search list system check, or a subnet mask system check;
executing the one or more systems checks, wherein each system check of the one or more system checks performs a comparison of an operating condition of a DHCP system to a target condition; and
effecting creation of a ticket for recording a result of the comparison.

19. The system of claim 18 wherein:
the gateway system check comprises:
comparing a gateway IP address from a DHCP server to a virtual IP address obtained from a configuration of a gateway server to ensure that the gateway IP address from the DHCP server is the virtual IP address discovered from gateway servers when redundant gateway servers exist;
the DNS system check comprises:
comparing a DNS servers list provided by a DHCP server to an approved DNS server list to ensure that all servers listed on the DNS servers list provided by a DHCP server are from the approved DNS server list;
the domain search list system check comprises:
comparing a domain search list provided by a DHCP server to an approved domain search list to ensure that all servers listed on the domain search list provided by a DHCP server are from the approved domain search list; and
the subnet mask system check comprises:
comparing a subnet mask provided by a DHCP server to a subnet mask obtained from a configuration of a gateway server to ensure that the subnet mask provided by the DHCP server matches the subnet mask obtained from the gateway server.

20. The system of claim 19 wherein the one or more system checks include:
a Network Time Protocol (NTP) system check comprising:
comparing an NTP server list provided by a DHCP server to an approved NTP server list to ensure that all servers listed on the NTP server list provided by a DHCP server are from the approved NTP server list;
a Trivial File Transfer Protocol (TFTP) system check comprising:
comparing a non-proprietary TFTP server list provided by a DHCP server to an approved non-proprietary TFTP list to ensure that all servers listed on the non-proprietary TFTP server list provided by a DHCP server are from the approved non-proprietary TFTP server list; and
comparing a Proprietary TFTP server list provided by a DHCP server to an approved Proprietary TFTP server list to ensure that all servers listed on the Proprietary TFTP server list provided by a DHCP server are from the approved Proprietary TFTP server list;
a hostname override system check comprising:
comparing a hostname override occurrence to a hostname override policy to determine if non-approved hostname overrides exist;
a multi-net system check comprising:
comparing one or more gateway servers associated with each of a plurality of networks to determine if more than one of the plurality of networks are assigned to a same gateway server;
a multi-homed system check comprising:
comparing lease tables from a plurality of scopes to identify DHCP client devices occurring in more than one lease table as multi-homed devices and comparing the multi-homed devices to machine names occurring in an asset database to determine if non-authorized multi-homed devices exists; and
a firewall-drop system check comprising:
comparing messages drop entries in a firewall log to one or more DHCP client devices to determine if DHCP messages are being dropped and
wherein the at least one of the gateway system check, the domain name server (DNS) system check, the domain search list system check, or the subnet mask system check includes all of the gateway system check, the domain name server (DNS) system check, the domain search list system check, the subnet mask system check, the Network Time Protocol (NTP) system check, the Trivial File Transfer Protocol (TFTP) system check, the hostname override system check, the multi-net system check, the multi-homed system check, and the firewall-drop system check.
